(19) United States
(12) Patent Application Publication
(10) Pub. No.: US 2026/0340001 A1
(43) Pub. Date: Oct. 29, 2026

(54) PROGRAMMING LANGUAGE AND METHOD FOR CONVERTING QUERIES TO THE PROGRAMMING LANGUAGE

(71) Applicant: Intuit Inc., Mountain View, CA (US)

(72) Inventors: Shutendra Kirty HARSOLA, Bangalore (IN); Deepak GUJRANIYA, Bangalore (IN); Aniruddha BARDHAN, Bengaluru (IN); Vikas RATURI, Bangalore (IN); Mohammad Saman TAMKEEN, Bangalore (IN); Arkadeep BANERJEE, Bangalore (IN)

(73) Assignee: Intuit Inc., Mountain View, CA (US)

(21) Appl. No.: 19/195,570

(22) Filed: Apr. 30, 2025

(30) Foreign Application Priority Data
Apr. 25, 2025 (IN) 202541040076

(51) Int. Cl. G06F 16/3332

(52) U.S. Cl. CPC G06F 16/3332

(57) ABSTRACT

A method including receiving a natural language query to an answer generation model. A first prompt is generated that instructs a conversion language model to convert the natural language query into a domain-specific language corresponding to the domain of the natural language query. The domain-specific language includes predefined terms representable in a predefined data structure. The conversion language model converts the first prompt to generate an instance data structure of the predefined data structure. The instance data structure stores the natural language query as expressed in a subset of the terms of the domain-specific language. A second prompt is generated. The second prompt includes the instance data structure, which instructs the answer generation model to generate a response to the natural language query. The answer generation model executes the second prompt to generate an answer to the natural language query. The answer is returned.

### CROSS-REFERENCE TO RELATED APPLICATIONS

This application claims priority to Indian provisional patent application No. 202541040076, filed Apr. 25, 2025, the entirety of which is hereby incorporated by reference. Additionally, this application is related to U.S. application Ser. No. ______, corresponding to attorney docket number 2513814US2; INU-958-B 762248, filed on the same date as this patent application.

### BACKGROUND

Language models are a type of deep learning machine learning model that may be used to perform natural language tasks. For example, language models can summarize large amounts of text, generate new text describing a subject of interest, etc. Language models also can be used to answer queries.

However, language models suffer from a significant number of limitations. One of the limitations is that language models are often inaccurate or return wrong information when an open-ended query is submitted to the language model regarding information in a database. When a language model returns wrong or nonsensical answers, the language model may be said to “hallucinate,” though language models do not hallucinate as a human might hallucinate.

For example, assume that a language model has access to a database storing financial information used by an application-specific financial management application. The language model supports the application-specific financial management application and may answer various questions for the user. The user submits the following query to the language model: “How is my business doing?” The language model accesses the database but is unable to interpret what the user intends because the question is too general. As a result, the language model either returns an output indicating that the language model is unable to process the query, or the language model hallucinates, such as to return the output: “Fine, how are you?” The user becomes frustrated, particularly if the user is not trained to generate structured queries that would return the information sought from the database.

Thus, a technical problem is presented. The technical problem is solving the above-mentioned language model difficulties, and in particular the technical problem is improving a computer in a manner that permits a language model to return an appropriate output in response to general or ambiguous questions pertaining to information in a database rather than a useless and potentially detrimental hallucination.

### SUMMARY

One or more embodiments provide for a method. The method includes receiving a natural language query to an answer generation model. The natural language query includes a domain. The method also includes generating a first prompt that instructs a conversion language model to convert the natural language query into a domain-specific language corresponding to the domain of the natural language query. The domain-specific language includes a number of predefined terms representable in a predefined data structure. The method also includes executing, by the conversion language model, the first prompt to generate an instance data structure of the predefined data structure. The instance data structure stores the natural language query as expressed in a subset of the number of predefined terms of the domain-specific language. The method also includes generating a second prompt that instructs the answer generation model to generate a response to the natural language query. The second prompt includes the instance data structure. The method also includes executing, by the answer generation model, the second prompt to generate an answer to the natural language query. The method also includes returning the answer.

One or more embodiments also include a system. The system includes a computer processor and an answer generation model in communication with the computer processor. The system also includes a conversion language model in communication with the computer processor. The system also includes a data repository in communication with the computer processor. The data repository stores a natural language query to the answer generation model and including a domain. The data repository also stores a first prompt that instructs the conversion language model to convert the natural language query into a domain-specific language corresponding to the domain of the natural language query. The domain-specific language includes a number of predefined terms representable in a predefined data structure. The data repository also stores an instance data structure of the predefined data structure. The instance data structure stores the natural language query as expressed in a subset of the number of predefined terms of the domain-specific language. The data repository also stores a second prompt that instructs the answer generation model to generate a response to the natural language query. The second prompt includes the instance data structure. The data repository also stores an answer to the natural language query. The system also includes a server controller executable by the computer processor to receive the natural language query and generate the first prompt. The server controller is also executable to execute the conversion language model on the first prompt to generate the instance data structure. The server controller is also executable to generate the second prompt. The server controller is also executable to execute the answer generation model on the second prompt to generate the answer. The server controller is also executable to return the answer.

One or more embodiments provide for a method. The method includes receiving a natural language query to an answer generation model. The natural language query includes a domain. The method also includes generating a first prompt that instructs a conversion language model to convert the natural language query into a domain-specific language corresponding to the domain of the natural language query. The domain-specific language includes a number of predefined terms representable in a predefined data structure. Generating the first prompt further also includes generating a third prompt that instructs a ranking model to select, from among a number of examples, a subset of examples. Each of the number of examples includes an example natural language query and an example instance data structure of the predefined data structure. The example instance data structure stores the example natural language query as expressed in an example subset of the number of predefined terms of the domain-specific language. The subset of examples includes a ranked list of examples that most closely pertain to the natural language query, relative to remaining examples in the number of examples. The ranking model includes a bidirectional encoder representations from transformers (BERT) language model. Generating the first prompt further also includes executing, by the ranking model, the third prompt to generate the subset of examples. Generating the first prompt further also includes inserting the subset of examples into the first prompt. The method also includes executing, by the conversion language model, the first prompt to generate an instance data structure of the predefined data structure. The instance data structure stores the natural language query as expressed in a subset of the number of predefined terms of the domain-specific language. The instance data structure defines an entity contained in the natural language query. The method also includes disambiguating the entity to generate a revised entity that corresponds to an entry in a database. The entity includes a first term, and the entry includes a second term different than the first term. The method also includes revising the instance data structure to generate a revised instance data structure. The method also includes generating a second prompt that instructs the answer generation model to generate a response to the natural language query. The second prompt includes the revised instance data structure. The method also includes executing, by the answer generation model, the second prompt to generate an answer to the natural language query. The method also includes returning the answer.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows a flowchart of a method for converting queries to an improved programming language, in accordance with one or more embodiments.

FIG. 3A, FIG. 3B, and FIG. 3C show an example of a method for converting queries to an improved programming language, in accordance with one or more embodiments.

FIG. 4A and FIG. 4B show a computing system and network environment, in accordance with one or more embodiments.

Like elements in the various figures are denoted by like reference numerals for consistency.

### DETAILED DESCRIPTION

One or more embodiments are directed to a technical solution to the above-identified technical problem. In brief, the technical solution is to use an ensemble of language models, together with a new domain-specific language, to convert natural language queries into instances of a predefined data structure in the domain-specific language. When an answer generation model (a language model) executes on the instance data structure, the answer generation model will generate an output that is much more likely to answer the intent of the user's question, rather than to return an error code or to generate an output that represents a hallucination of a language model. The output of the answer generation model is improved because the input is structured in a manner to provide more specific instructions to the language model, relative to the original natural language query.

A more detailed overview of the technical solution is now presented. Initially, a natural language query is received. The natural language query is intended, by a user, to be submitted to a language model referred to herein as an answer generation model. In response, a first prompt is generated. The first prompt is a set of commands and other information in natural language that instructs another language model, referred to herein as a conversion language model, to convert the natural language query into a domain-specific language corresponding to a domain of the natural language query. The domain is a subject of the query or area of knowledge. The domain-specific language includes predetermined terms, as described further below, that are representable in a predefined data structure. The predefined data structure is a structured language data structure that forces objects, commands, etc. to take certain forms that the answer generation model recognizes.

Next, the conversion language model is executed on the first prompt. The output of the conversion language model is an instance data structure. An instance data structure is a specific instance of the predefined data structure, and thus contains data specific to the natural language query and a selection of commands available taken from those commands available to the domain-specific language. Accordingly, the instance data structure stores the natural language query as expressed in a subset of a number of predefined terms of the domain-specific language.

Next, a second prompt is generated. The second prompt instructs the answer generation model to generate a response to the natural language query by executing on the instance data structure. The answer generation model is then executed on the second prompt to generate an answer to the query. Because the instance data structure provides specificity, structure, and precise instructions to the answer generation model, the output of the answer generation model is improved. In particular, the output of the answer generation model in this regard is less likely to represent a hallucination, relative to the output of the answer generation model had the natural language query been submitted directly to the answer generation model. The answer output by the natural language query is then returned. For example, the answer may be displayed to a user, stored for future use, etc.

Additional details regarding one or more embodiments are presented below. Additionally, one or more embodiments may include additional steps that further enhance the answer. Thus, attention is now turned to the figures.

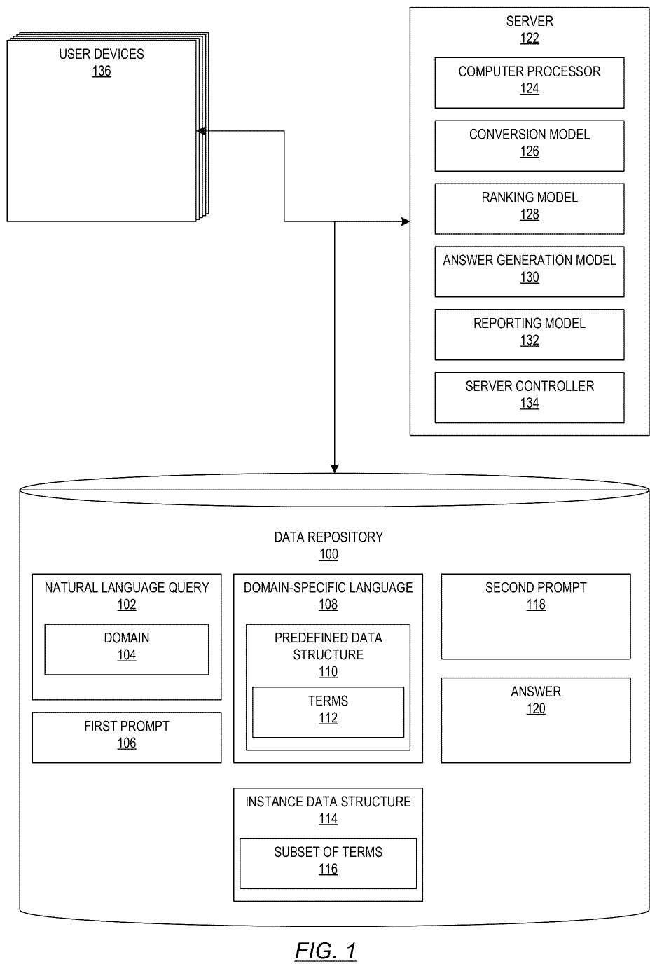

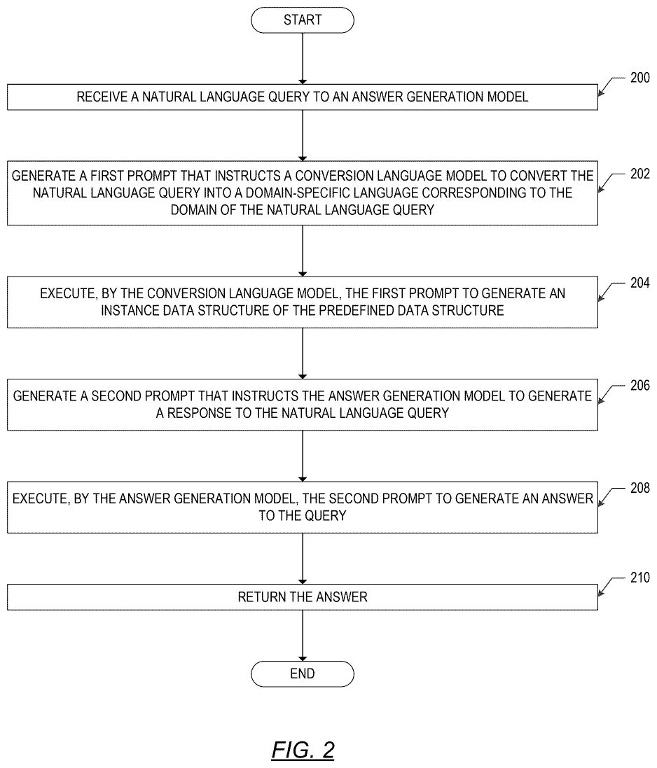

FIG. 1 shows a computing system, in accordance with one or more embodiments. The system shown in FIG. 1 includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) stores a natural language query (102). The natural language query (102) is a query submitted from a user device (e.g., one of the user devices (136) defined below) or from some other process, where the query is expressed in a natural language using alphanumeric text.

The natural language query (102) is associated with, or assigned, a domain (104). A domain (104) is an area of knowledge or a subject of the natural language query (102). For example, if the domain (104) pertains to financial management questions, then the domain (104) may be financial management. In another example, if the domain (104) pertains to documents having the portable document file (PDF) file extension, then the domain may be PDFs.

The domain (104) may be useful in one or more embodiments, as the domain may indicate that certain commands or structures be potentially available in the domain-specific language (108) (defined below) should be made available for selection in the predefined data structure (110) when the instance data structure (114) (defined below) is generated from the predefined data structure (110). Stated differently, different domains may indicate the desirability of different commands or data structures being made available in the predefined data structure (110) for when the instance data structure (114) is generated as described with respect to FIG. 2. The domain-specific language (108) also may be referred to as an intermediate representation of the natural language query (102), as the domain-specific language (108) allows the natural language query (102) to be translated into the instance data structure (114) which is better suited for processing by the answer generation model (130) (defined below).

The data repository (100) also stores a first prompt (106). The first prompt (106) is a prompt to be submitted to the conversion model (126) (defined below). A prompt, generally, is natural language instructions to a language model that describe the task the language model is to perform, constraints on the language model when performing the task, and possibly other instructions or data (such as the examples selected by the ranking model (128) (defined below), as described with respect to FIG. 2). The first prompt (106), in particular, is instructions to the conversion model (126).

More specifically, the first prompt (106) instructs the conversion model (126) to convert the natural language query (102) into a domain-specific language (108) (defined below) corresponding to the domain (104) of the natural language query (102). The domain-specific language (108), as defined more fully below, includes a number of predefined terms (112) representable in a predefined data structure (110) (all defined below). The instructions and use of the prompt are described with respect to step 202 of FIG. 2.

The data repository (100) also stores a domain-specific language (108). The domain-specific language (108) is, as indicated above, a number of predefined terms (112) representable in a predefined data structure (110). The language may be expansive and contain many possible terms (112) that may be combined into an instance data structure (114), just as natural language may be expansive and contain many possible words that may be combined into phrases, sentences, paragraphs, etc.

The predefined data structure (110) has a defined structure that may be expressed in a structured language format. Thus, for example, the predefined data structure (110) defines a symbology (defined below) that indicates the type of the terms (112) expressed in the predefined data structure (110), an order of execution of instruction terms, instructions for beginning and ending an instance data structure (114), etc.

The predefined data structure (110) also includes a number of terms (112), as indicated above. The terms (112) include at least two types of terms, entity terms and instruction terms. An entity term defines an entity (e.g., a name, data to be stored in the instance data structure (114), etc.). An instruction term is a command.

The domain-specific language (108) also includes a type of the terms (112) that is not found in other structure languages (e.g., structure query language (SQL), python, etc.). In particular, the terms (112) include a type of term referred to as an insight term. An insight term is a single instruction term that requires multiple operations (i.e., second order operations) in order to return an output, or otherwise orders an operation not available in available structured languages.

The data repository (100) also stores an instance data structure (114). The instance data structure (114) is a specific instance of the predefined data structure (110). The instance data structure (114), in particular, may contain less than all (i.e., a subset) of the available commands, definitions, and other aspects of the domain-specific language.

Thus, the instance data structure (114) includes a subset of terms (116). The subset of terms (116) is a subset of the terms (112) available in the predefined data structure (110). The subset of terms (116) are also associated with specific information related to the natural language query (102) or domain (104), such as for example commands that are selected to implement the command specified or inferred from the natural language query (102), entity terms specified or inferred from the natural language query (102), a domain designation for the domain (104), etc.

Examples and details of the domain-specific language (108), the predefined data structure (110), the terms (112), the instance data structure (114), and the subset of terms (116) are now provided. Most generally, the domain-specific language (108) may be defined according to a predetermined template, which is the predefined data structure (110). The predefined data structure (110) may be expressed, in one example, as follows:

```
{“function_name”: “<dataset_name>“, “attributes” : {
  “Transaction_date” : { “macroName”: <macroValue> },
  <create_dervied_column>,
  <Filter_string_column>,
  <Filter_date_column>,
  <Filter_numerical_column>,
  “Groupby”: [ <column_1> , ... , <column_n> ],
  “Aggregation”: { <agg_column> : <agg_function> },
  “Sortby”: { <column> : <asc/desc> },
  “Limit” : <n>,
  “Insight”:{<type>,<kpi>,<granularity>,...}
} }
```

Each statement (a word or a group of words connected by an underscore, “_”) is an example of one of the terms (112). The above example of the predefined data structure (110) may contain additional terms (112). However, the data repository (100) may include fewer terms or modified terms (112). In an embodiment, the term “<dataset_name>” may be used during the conversion of each received natural language query (102). Other examples of the terms (112) and various attributes expressed in the example predefined data structure (110) above may be optional and may be added when useful for answering a specific natural language query (102).

The following table shows example definitions of the terms (112) presented in the above example of the predefined data structure (110), along with examples:

| Dataset_name | Sales / bills / invoice / expenses / profit_loss etc |
|---|---|
| Filter_transaction_date | “transaction_date”: { “macroName”: “THIS_YEAR”} |
| | “transaction_date” : {“macroName”: “CUSTOM”, |
| | “startDate”: “2024-01-01”, “endDate”: “2024-01-15”} |
| | Note: transaction_date is a special date column which is |
| | common across all datasets and supports filtering via |
| | macros |
| Filter_string_column | “vendor” : [“Business Name”, “Business Alias”] |
| | “account” : [“Utilities”] |
| Filter_date_column | “due_date” : {“less_than”: “2024-02-01” , |
| | “greater_than”: “2024-01-15”} |
| Filter_numerical_column | “open_balance” : {“greater_than”: 0} |
| | “amount” : {“less_than”: 500}, |
| create_derived_column | <new_column_name>: {<udf>: |
| | [<column_1>,...,<column_n>] } Note: udf is a custom |
| | python function defined in the data QnA. |
| Groupby + Aggregation | “groupby” : [“account”], “aggregation” : {“open_balance”: |
| | “sum” } Note: Aggregated column name would be |
| | “<agg_function>_<agg_column>“ |
| Sort + Limit | “sortby”: {“sum_open_balance”: “desc”}, “limit”: 5 |
| Insight | “Insight”: { |
| | “type”:”trend”, |
| | “kpi”:”sales”, |
| | “granularity”:[“month”,”quarter”] |
| | } |

The natural language query (102) may include first order fact questions. First order fact questions may be answered by making a single call to a reporting application programming interface (API) of a database or to an application.

An example of an instance data structure (114) of a first order fact question is provided below. The natural language query (102) is, “What are the top 5 accounts with unpaid bills for ‘Business Name’ shown this quarter?”

{“function_name”: “bills”, “attributes” : {
“transaction_date”: { “macroName”: “this_quarter”},
“vendor” : [“Business Name”],
“open_balance” : {“greater_than”: 0},
“groupby” : [“account”],
“aggregation” : {“open_balance”: “sum” },
“sortby”: {“sum_open_balance”: “desc”},
“limit” : 5
} }

In the above example, the subset of terms (116) include entity terms such as “function_name,” “transaction_date,” “vendor,” and “open_balance.” The subset of terms (116) also include command terms, such as “groupby,” “aggregation,” “sortby,” and “limit.”

The natural language query (102) may include first order insight questions. First order insight questions can be answered by making a single call to an insights API software development kit that handles pulling required data internally. An example of a first order insight question as a natural language query is, “Business Brief: What is the most important thing I should know about my finances today?” The instance data structure (114) for this natural language query, generated from the predefined data structure (110), and including a different subset of terms (116) may be as follows:

{“function_name”: “profit_loss”, “attributes” : {
“transaction_date”: { “macroName”: “THIS_YEAR_TO_DATE”}, } }

The natural language query (102) may include first order benchmarking questions. First order insight questions can be answered by making a single call to an insights API software development kit that handles pulling required data internally. An example of a first order benchmarking question may be, “Benchmarking Insight: Am I effectively managing utilities and energy consumption to reduce costs?” The instance data structure (114) and the subset of terms (116) for the question may be expressed as follows:

{“function_name”: “expense”, “attributes” : {
“transaction_date”: { “macroName”: “THIS_YEAR_TO_DATE”},
“insight”:{“type”:”benchmark”, “kpi”:”expense”, “granularity”:”account”}
} }

The natural language query (102) also may include second order insight questions. Second order insight questions may be answered by using a reporting API call followed by executing an insights method on the returned data. An example of a second order insight question may be a comparison insight question, such as, “What products have shown a decline sales of more than 50% this month to previous month?” Another second order insight question may be, “Are there any trends in sales growth or decline over different periods?” The instance data structure (114) and the subset of terms (116) for the question may be expressed as follows:

(months, quarters) for customer C1?
{“function_name”: “sales”, “attributes” : {
“transaction_date”:[“macroName”:”THIS_YEAR_TO_DATE”],
“Customer”: “C1”,
“Insight”:{
“type”:”trend”,
“kpi”:”sales”,
“Granularity”: [“month(transaction_date)”, “quarter(transaction_date)” ]
}
} }

Another second order insight question may be, “Can I identify any customer segments driving the most sales?” The instance data structure (114) and the subset of terms (116) for the question may be expressed as follows:

{“function_name”: “sales”, “attributes” : {
“transaction_date”:[“macroName”:”THIS_YEAR_TO_DATE”],
“insight”:{“type”:”contribution”, “kpi”:”sales”,
“granularity”:[“segment(customer)”] } } }

The data repository (100) also stores a second prompt (118). The second prompt (118) is a prompt for a language model, as is the first prompt (106). However, the second prompt (118) instructs the answer generation model (130) to generate a response to the natural language query (102). The second prompt (118) will include the instance data structure (114) generated for the natural language query (102). The second prompt (118) also may include other instructions to the answer generation model (130) with respect to generating the answer (120).

The answer (120) is the output of the answer generation model (130). The answer (120), specifically, is the answer to the natural language query (102) that is reported (i.e., returned to one of the user devices (136), stored, transmitted to another process, etc.)

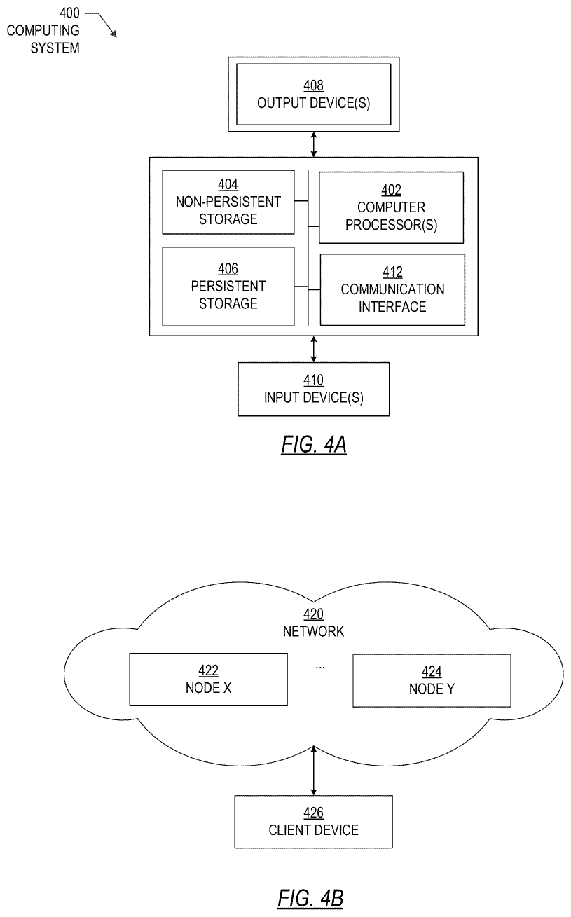

The system shown in FIG. 1 may include other components. For example, the system shown in FIG. 1 also may include a server (122). The server (122) is one or more computer processors, data repositories, communication devices, and supporting hardware and software. The server (122) may be in a distributed computing environment. The server (122) is configured to execute one or more applications, such as the conversion model (126), the ranking model (128), the answer generation model (130), the reporting model (132), and the server controller (134). An example of a computer system and network that may form the server (122) is described with respect to FIG. 4A and FIG. 4B.

The server (122) includes a computer processor (124). The computer processor (124) is one or more hardware or virtual processors which may execute computer readable program code that defines one or more applications, such as the conversion model (126), the ranking model (128), the answer generation model (130), the reporting model (132), and the server controller (134). An example of the computer processor (124) is described with respect to the computer processor(s) (402) of FIG. 4A.

The server (122) also includes a variety of language models, including the conversion model (126), the ranking model (128), the answer generation model (130), and the reporting model (132). Because each of the models may be a language model, each of the models share some common characteristics.

For example, a language model is a natural language processing machine learning model. An example of the language model may be a large language model, such as CHATGPT® by OpenAI. However, different language models may be used for the conversion model (126), the ranking model (128), the answer generation model (130), or the reporting model (132).

In addition, some or all of the conversion model (126), the ranking model (128), the answer generation model (130), and the reporting model (132) may be the same or different language models. For example, the same language model could perform each of the functions of the conversion model (126), the ranking model (128), the answer generation model (130), and the reporting model (132). Conversely, each of the models may be different language models, possibly different types of language models. Some of the models may be the same model, and other different models. The primary distinguishing facet of each of the conversion model (126), the ranking model (128), the answer generation model (130), and the reporting model (132) is the function that each model performs in one or more embodiments, such as in the method of FIG. 2.

The conversion model (126) is a language model that converts the natural language query (102) into the instance data structure (114) according to the instructions of the first prompt (106). Thus, the input to the conversion model (126) is the natural language query (102) and the first prompt (106), and the output of the conversion model (126) is the instance data structure (114).

The ranking model (128) is a language model that selects, from among a set of examples, a subset of examples for inclusion in the first prompt (106) for the conversion model (126). The ranking model (128) (also referred to as a third model herein) may be a bidirectional encoder representations from transformers (BERT) language model, but also may be some other type of language model.

The input to the ranking model (128) is the natural language query (102), and the output of the ranking model (128) is one or more examples taken from the set of examples that are available. Each example is a sample question and a sample instance data structure (114) that represents the question in the domain-specific language. The input to the ranking model (128) also may include an additional prompt (a “ranking prompt”) that contains other instructions and constraints on how to select the subset of examples from the set of examples.

In an embodiment, ten to twenty examples taken from the example set may be inserted into the first prompt (106) on which the conversion model (126) is executed. The subset of examples may be the top “N” number of examples, as ranked by the ranking model (128).

The answer generation model (130) is a language model that generates the answer (120). The input to the answer generation model (130) is the second prompt (118), which includes the instance data structure (114) output by the conversion model (126). The output of the answer generation model (130), as indicated above, is the answer (120).

The reporting model (132) may be present in some embodiments. The reporting model (132) is a language model that converts the answer (120) into a narrative format that may be easier for some users to interpret. For example, the input to the reporting model (132) may be the answer (120), and the output of the reporting model (132) may be a narrative summary or narrative restatement of the answer (120). The input to the reporting model (132) also may include an additional prompt (a “reporting prompt”) that contains other instructions and constraints on how to format the answer (120). The output of the reporting model (132) is a reformatted answer or modified answer. The reformatted or modified answer may be returned to a user device, stored, transmitted to a different computer process, etc.

The server (122) also may include a server controller (134). The server controller (134) is software or application-specific hardware which, when executed by the computer processor (124), controls and coordinates operation of the software or application-specific hardware described herein. Thus, the server controller (134) may control and coordinate execution of the conversion model (126), the ranking model (128), the answer generation model (130), and the reporting model (132). The server controller (134) also may execute the method of FIG. 2 and the variations thereof.

The system shown in FIG. 1 also may include one or more user devices (136). The user devices (136) are computing systems (e.g., the computing system (400) shown in FIG. 4A) that communicate with the server (122).

The user devices (136) may be considered remote or local. A remote user device is a device operated by a third-party (e.g., an end user of a chatbot) that does not control or operate the system of FIG. 1. Similarly, the organization that controls the other elements of the system of FIG. 1 may not control or operate the remote user device. Thus, a remote user device may not be considered part of the system of FIG. 1. In contrast, a local user device is a device operated under the control of the organization that controls the other components of the system of FIG. 1. Thus, a local user device may be considered part of the system of FIG. 1.

While FIG. 1 shows a configuration of components, other configurations may be used without departing from the scope of one or more embodiments. For example, various components may be combined to create a single component. As another example, the functionality performed by a single component may be performed by two or more components.

FIG. 2 shows a flowchart of a method for converting queries to an improved programming language, in accordance with one or more embodiments. The method of FIG. 2 may be implemented using the system of FIG. 1 and one or more of the steps may be performed on or received at one or more computer processors.

Step 200 includes receiving a natural language query to an answer generation model. The natural language query includes a domain. The natural language query may be received from one or more user devices. The natural language query may be received from an automated process, or from a remote server that calls the server controller.

Step 202 includes generating a first prompt that instructs a conversion language model to convert the natural language query into a domain-specific language corresponding to the domain of the natural language query. The domain-specific language includes a number of predefined terms representable in a predefined data structure.

Generating the first prompt includes a command to convert the natural language query into the domain-specific language by converting the natural language query into an instance data structure of a predefined data structure. The first prompt may include other instructions, and in particular may include examples of other questions and additional instance data structures into which the other questions are converted.

Thus, generating the first prompt at step 202 also may include generating a third prompt that instructs a ranking model to select, from among a number of examples, a subset of examples. Each of the number of examples includes an example natural language query and an example instance data structure of the predefined data structure. The instance data structure stores the example natural language query as expressed in an example subset of the number of predefined terms of the domain-specific language. The subset of examples includes a ranked list of examples that most closely pertain to the natural language query, relative to remaining examples in the number of examples. The ranking model then executes the third prompt to generate (i.e., output) the subset of examples. The subset of examples are then inserted into the first prompt.

Step 204 includes executing, by the conversion language model, the first prompt to generate an instance data structure of the predefined data structure. The instance data structure stores the natural language query as expressed in a subset of the number of predefined terms of the domain-specific language.

The instance data structure may be generated by executing, by the conversion model, a first prompt that includes a dataset name in the domain-specific language and a subset of entity terms defined in the domain-specific language and contained in the natural language query. The instance data structure output by the conversion model further includes a subset of terms selected from among a number of terms defined in the number of predefined terms. The dataset name includes a subset of dataset names selected from among a number of dataset names defined in the number of predefined terms.

Step 206 includes generating a second prompt that instructs the answer generation model to generate a response to the natural language query. The second prompt includes the instance data structure. The second prompt may include additional commands or constraints on the answer generation model when executing on the second prompt. For example, the second prompt may command the answer generation model to refer to a context (i.e., a source of data stored in a data repository) when generating the answer. An example of a context may include rules promulgated by an external source (e.g., tax rules by the U.S. Internal Revenue Service (IRS), scientific formulae, etc.)

Step 208 includes executing, by the answer generation model, the second prompt to generate an answer to the query. Executing the second prompt is performed by commanding the answer generation model to execute the second prompt and any instructions contained therein. The output of the answer generation model is the answer.

Step 210 includes returning the answer. The answer may be returned by transmitting the answer to one or more user devices or displaying the answer on one or more user devices. The answer also may be returned by storing the answer. The answer also may be returned by transmitting the answer to another computer process, such as for example a process that called the server controller (134) to generate the answer. The answer may be returned according to other techniques, as well.

The method of FIG. 2 may be varied. The method of FIG. 2 may include more or fewer steps or may contain modified steps.

For example, assume that the instance data structure defines an entity contained in the natural language query. In this case, the method also may include disambiguating the entity to generate a revised entity that corresponds to an entry in a database.

Disambiguation may be performed by a fuzzy matching algorithm, yet another language model, or some other algorithm may also perform disambiguation. For example, the Jaro-Winkler Similarity algorithm may be used to perform the disambiguation. Disambiguation resolves entity terms that could have multiple meanings, and instead returns a single entity determined to be the original entity which is pertinent to the natural language query.

For example, assume that the entity includes a first term, and the entry includes a second term different than the first term. Disambiguation may include revising, prior to executing the second prompt, the instance data structure to generate a revised instance data structure that includes the revised entity. In this case, the second prompt includes the revised entity by way of the revised instance data structure.

In another variation of the method of FIG. 2, where the answer is defined as a second instance of the domain-specific language. In other words, the answer may be presented in a structured language data format (e.g., the domain-specific language identified above, a structured query language, python, etc.) In this case, a third prompt may be generated that instructs a reporting model to convert the second instance of the domain-specific language into a natural language answer. The natural language answer may include a summary, interpretation, or rewording of the second instance of the domain-specific language. In the variation, returning the answer includes returning the natural language answer.

In another variation of the method of FIG. 2, the instance data structure includes a command to an application-specific program. In this case, the method further includes calling, prior to executing the second prompt, an application programming interface (API) of the application-specific program and requesting the application-specific program to execute the command. The method then includes receiving, via the API, an output of the application-specific program. The method then includes revising the instance data structure by inserting the output into the instance data structure to generate a revised instance data structure. The second prompt includes the revised instance data structure.

In another variation of the method of FIG. 2, the instance data structure includes a first command to an application-specific program and a second command to a domain-specific program. In this case, the method further includes calling, prior to executing the second prompt, a first application programming interface (API) of the application-specific program and requesting the application-specific program to execute the first command. The method then includes receiving, via the first API, a first output of the application-specific program. The method then includes calling, prior to executing the second prompt, a second API of the domain-specific program related to the domain and requesting the domain-specific program to execute the second command using the first output. The method then includes receiving, via the second API, a second output of the domain-specific program. The method then includes revising the instance data structure by inserting the second output into the instance data structure to generate a revised instance data structure. The second prompt includes the revised instance data structure.

Other variations are possible. In an extended example, a variant of FIG. 2 may include receiving a natural language query to an answer generation model. the natural language query includes a domain. The variant method also includes generating a first prompt that instructs a conversion language model to convert the natural language query into a domain-specific language corresponding to the domain of the natural language query. The domain-specific language includes a number of predefined terms representable in a predefined data structure.

Generating the first prompt further includes generating a third prompt that instructs a ranking model to select, from among a number of examples, a subset of examples. Each of the number of examples includes an example natural language query and an example instance data structure of the predefined data structure. The instance data structure stores the example natural language query as expressed in an example subset of the number of predefined terms of the domain-specific language. The subset of examples includes a ranked list of examples that most closely pertain to the natural language query, relative to remaining examples in the number of examples. The ranking model includes a bidirectional encoder representations from transformers (BERT) language model.

The variant method also includes executing, by the ranking model, the third prompt to generate the subset of examples. The variant method also includes inserting the subset of examples into the first prompt.

The variant method also includes executing, by the conversion language model, the first prompt to generate an instance data structure of the predefined data structure. The instance data structure stores the natural language query as expressed in a subset of the number of predefined terms of the domain-specific language. The instance data structure defines an entity contained in the natural language query.

The variant method also includes disambiguating the entity to generate a revised entity that corresponds to an entry in a database. The entity includes a first term, and the entry includes a second term different than the first term. The variant method also includes revising, prior to executing the second prompt, the instance data structure to generate a revised instance data structure.

The variant method also includes generating a second prompt that instructs the answer generation model to generate a response to the natural language query. The second prompt includes the revised instance data structure.

The variant method also includes executing, by the answer generation model, the second prompt to generate an answer to the query. The answer is returned, as described above.

In the above variant method, the revised instance data structure includes a first command to an application-specific program and a second command to a domain-specific program. In this case, the variant method also includes calling, prior to executing the second prompt, a first application programming interface (API) of the application-specific program and requesting the application-specific program to execute the first command. The variant method also includes receiving, via the first API, a first output of the application-specific program.

The variant method also includes calling, prior to executing the second prompt, a second API of the domain-specific program related to the domain and requesting the domain-specific program to execute the second command using the first output. The variant method also includes receiving, via the second API, a second output of the domain-specific program. The variant method also includes revising the revised instance data structure by inserting the second output into the instance data structure to generate a second revised instance data structure. The second prompt includes the second revised instance data structure in place of the revised instance data structure.

While the various steps in the flowchart of FIG. 2 are presented and described sequentially, at least some of the steps may be executed in different orders, may be combined or omitted, and at least some of the steps may be executed in parallel. Furthermore, the steps may be performed actively or passively.

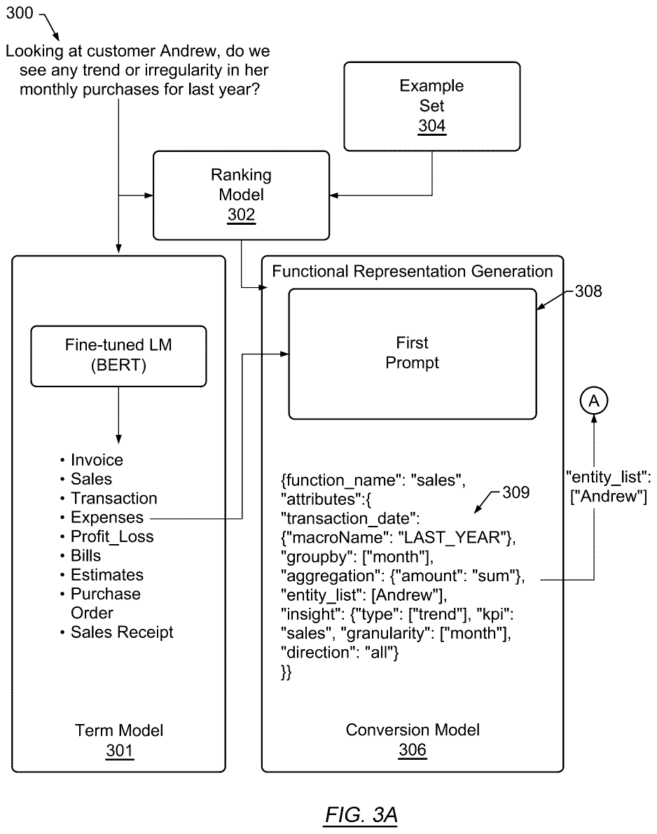

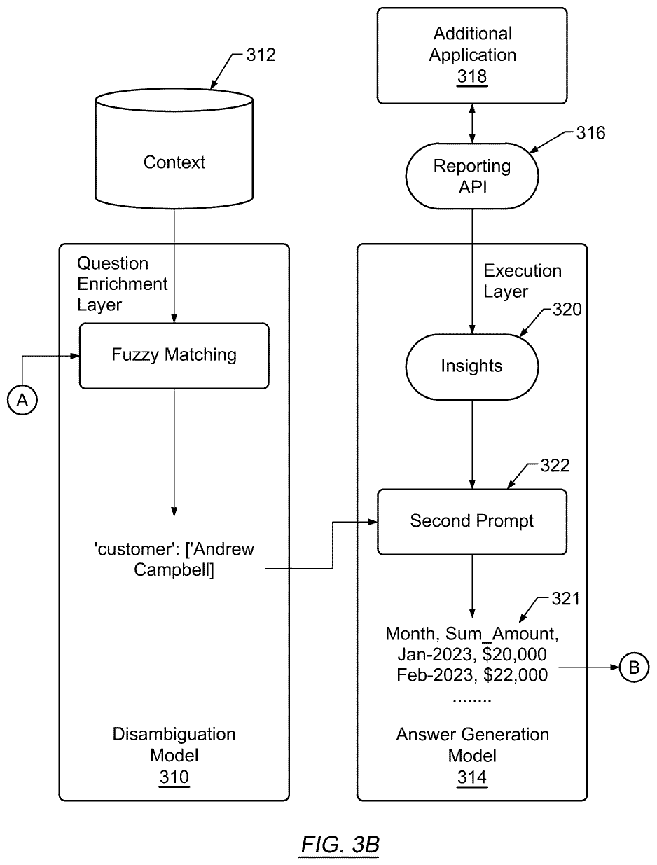

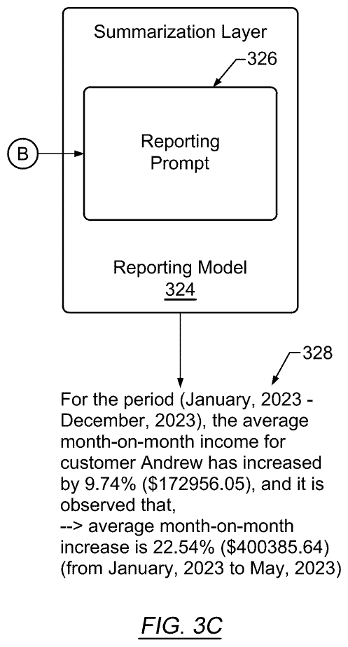

FIG. 3A, FIG. 3B, and FIG. 3C show an example of a method for converting queries to an improved programming language, in accordance with one or more embodiments. FIG. 3A through FIG. 3C should be considered together as a whole. The following example is for explanatory purposes only and not intended to limit the scope of one or more embodiments. The pictorial method shown in FIG. 3A through FIG. 3C may be a variation of the method shown in FIG. 2.

The method of the example is in the context of a language model that supports users of a financial management application. The financial management application organizes and analyzes the user's finances. However, a language model ensemble (e.g., the conversion model (126), the ranking model (128), the answer generation model (130), and the reporting model (132) of FIG. 1) is used to implement the method of FIG. 2 to ensure that the ultimate answer to a finance question is accurate. The model ensemble includes additional language models (e.g., a term model, a disambiguation model, and a reporting model) that may be useful in one or more embodiments.

As shown in FIG. 3A, a natural language query (300) is received. The natural language query (300) is intended for execution by an answer generation model (314) (described below with respect to FIG. 3B). However, the answer generation model (314) is likely to hallucinate if the natural language query (300) is input directly to the answer generation model (314), because the natural language query (300) includes ambiguous terms (there are multiple persons named Andrew in the user's financial database), and terms such as “trend” or “irregularity” are not well defined in terms of functional commands to a computer. However, the process described with respect to FIG. 3A through FIG. 3C (and also with respect to FIG. 2) will cause the answer generation model (314) to output an answer (328) in FIG. 3C that is likely to be correct and not a hallucination of the answer generation model (314).

The first task to be performed in the example is to parse the natural language query (300) into entities and commands (e.g., the names of entities and commands that will be the basis for determining the instance of terms (i.e., the subset of terms (116) in FIG. 1). In the example, a term model (301) receives the natural language query (300) as input and generates, as output, a list of entities and or commands. In the example, the term model (301) is a fine-tuned language model (and may be a bidirectional encoder representations from transformers (BERT) language model).

Next, the natural language query (300) is also provided as input to a ranking model (302). The ranking model (302) also may be a BERT language model (and indeed may be the same model that constitutes the term model (301), but which is executed again with a different prompt). However, the ranking model (302) may be another type of language model. The ranking model (302) compares the natural language query (300) to a context, which in the example is an example set (304).

The example set (304) is pairs of natural language queries and corresponding instance data structures in the domain-specific language described with respect to FIG. 1.

The example set (304) may include thousands of examples or more. However, only those examples that are closer in relevance to the natural language query (300) are desirable. The ranking model (302) ranks the examples in the example set (304) and returns, as output, a top subset of examples that the ranking model (302) predicts are closest in relevance or closest in domain to the natural language query (300). In the example, the server controller is programmed to use the top fifteen examples in the example set (304) as a subset of examples. Each example in the subset examples is one natural language query and one expression of the natural language query correctly presented as an instance data structure in the domain-specific language.

The subset of examples is then inserted into a first prompt (308) intended for execution by a conversion model (306). The first prompt (308) also may include additional instructions, and thus may be a dataset-specific prompt. The first prompt (308) may include commands terms or entity terms output by the term model (301). The conversion model (306) is executed on the first prompt (308) and generates, as output, the instance data structure (309) shown in FIG. 3A. The instance data structure (309) is in the domain-specific language, and thus is a structured language data structure.

The instance data structure (309) is provided as input to a disambiguation model (310) in FIG. 3B. The disambiguation model (310) is useful because the entity “Andrew” in the instance data structure (309) could refer to multiple entries for multiple persons named “Andrew” in a context (312) used by the financial management application. In the example, the disambiguation model (310) is a fuzzy matching algorithm, but the disambiguation model (310) could be some other type of model (including a language model).

The input to the disambiguation model (310) is the instance data structure (309). The disambiguation model (310) compares the terms in the instance data structure (309) to the context (312). Because of the presence of non-ambiguous terms in the instance data structure (309), the disambiguation model (310) is able to identify a non-ambiguous term for the term “Andrew.” Namely, the disambiguation model (310) identifies that the “Andrew” named in the natural language query (300) corresponds to an entry for “Andrew Campbell” in the context (312). Note that the name “Andrew Campbell” in the example does not refer to a real person, and no resemblance is intended to a real person.

Nevertheless, the server controller substitutes the term “Andrew” in the instance data structure (309) with the term “Andrew Campbell.” The disambiguated version of the instance data structure (309) is then provided as input to the answer generation model (314).

The answer generation model (314) takes as input the disambiguated version of the instance data structure (309). Because one of the command terms in the instance data structure (309) includes an insight term (see the description of FIG. 1 for a definition of an “insight term”), the answer generation model (314) (or the server controller) calls a reporting application programming interface (reporting API (316). In turn, the reporting API (316) calls an additional application (318), which performs some or all of the processing desirable to obtain information for generating the insight term. For example, the additional application (318) may be one of the computing tools of the financial management application that performs calculations on the data stored in the query user's data storage which the financial management application accesses.

The additional application (318) returns the insight data via the reporting API (316). In turn, the one or more insights (320) are inserted into the disambiguated version of the instance data structure (309) to generate a final version of the instance data structure (309).

The final version of the instance data structure (309), together with a second prompt (322) (again, see FIG. 1 and FIG. 2 for a definition and use of a “second prompt”) are provided as input to the answer generation model (314). The output of the answer generation model (314) may be a data structure file (321) that contains a computer readable version of the data that may be used to constitute the ultimate answer (328). Alternatively, the data structure file (321) may contain the answer but be difficult to interpret by a user.

Thus, the data structure file (321) may be provided as input to a reporting model (324) in FIG. 3C. The reporting model (324) is another language model that is used to summarize, interpret, recharacterize, or otherwise modify the data structure file (321) in FIG. 3B so that the information contained in the data structure file (321) is easier for a user to understand. Thus, the input to the reporting model (324) is the data structure file (321) in FIG. 3B, together with possibly additional instructions contained in the reporting prompt (326) to the reporting model (324).

The output of the reporting model (324) is the answer (328) shown in FIG. 3C. The answer (328) is pertinent to the user, correct relative to the information contained in the context (312), and not a hallucination of the answer generation model (314). The answer (328) is also easily understandable by a user and drafted in a manner consistent with the natural language query (300).

Thus, whereas directly inputting the natural language query (300) in FIG. 3A to the answer generation model (314) in FIG. 3B very likely would have resulted in the answer generation model (314) generating a hallucination output, one or more embodiments improve the answer generation model (314) with a structured input that the answer generation model (314) may use to generate a correct and relevant answer. Accordingly, the method shown in FIG. 3A through FIG. 3C represents an example of a technical solution to the technical problem of improving a computer in a manner that permits a language model to return an appropriate output in response to general or ambiguous questions pertaining to information in a database.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 4A, the computing system (400) may include one or more computer processor(s) (402), non-persistent storage device(s) (404), persistent storage device(s) (406), a communication interface (408) (e.g., Bluetooth interface, infrared interface, network interface, optical interface, etc.), and numerous other elements and functionalities that implement the features and elements of the disclosure. The computer processor(s) (402) may be an integrated circuit for processing instructions. The computer processor(s) (402) may be one or more cores, or micro-cores, of a processor. The computer processor(s) (402) includes one or more processors. The computer processor(s) (402) may include a central processing unit (CPU), a graphics processing unit (GPU), a tensor processing unit (TPU), combinations thereof, etc.

The input device(s) (410) may include a touchscreen, keyboard, mouse, microphone, touchpad, electronic pen, or any other type of input device. The input device(s) (410) may receive inputs from a user that are responsive to data and messages presented by the output device(s) (412). The inputs may include text input, audio input, video input, etc., which may be processed and transmitted by the computing system (400) in accordance with one or more embodiments. The communication interface (408) may include an integrated circuit for connecting the computing system (400) to a network (not shown) (e.g., a local area network (LAN), a wide area network (WAN) such as the Internet, mobile network, or any other type of network) or to another device, such as another computing device, and combinations thereof.

Further, the output device(s) (412) may include a display device, a printer, external storage, or any other output device. One or more of the output device(s) (412) may be the same or different from the input device(s) (410). The input device(s) (410) and output device(s) (412) may be locally or remotely connected to the computer processor(s) (402). Many different types of computing systems exist, and the aforementioned input device(s) (410) and output device(s) (412) may take other forms. The output device(s) (412) may display data and messages that are transmitted and received by the computing system (400). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (402), is configured to perform one or more embodiments, which may include transmitting, receiving, presenting, and displaying data and messages described in the other figures of the disclosure.

The computing system (400) in FIG. 4A may be connected to, or be a part of, a network. For example, as shown in FIG. 4B, the network (420) may include multiple nodes (e.g., node X (422) and node Y (424), as well as extant intervening nodes between node X (422) and node Y (424)). Each node may correspond to a computing system, such as the computing system shown in FIG. 4A, or a group of nodes combined may correspond to the computing system shown in FIG. 4A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (400) may be located at a remote location and connected to the other elements over a network.

The nodes (e.g., node X (422) and node Y (424)) in the network (420) may be configured to provide services for a client device (426). The services may include receiving requests and transmitting responses to the client device (426). For example, the nodes may be part of a cloud computing system. The client device (426) may be a computing system, such as the computing system shown in FIG. 4A. Further, the client device (426) may include or perform all or a portion of one or more embodiments.

The computing system of FIG. 4A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

1. A method comprising:
receiving a natural language query to an answer generation model, wherein the natural language query comprises a domain, wherein the domain comprises a subject of the natural language query or an area of knowledge;
generating a first prompt that instructs a conversion language model to convert the natural language query into a domain-specific language corresponding to the domain of the natural language query, wherein:
the domain is associated with a command or structure expressed in the domain-specific language and the domain-specific language is specific to the domain,
the domain-specific language comprises a plurality of predefined terms, as used in the subject of the query or the area of knowledge of the domain, representable in a predefined data structure,
the plurality of predefined terms include the command or structure of the domain,
the first prompt includes a predefined data structure template that includes the command or structure,
the predefined data structure template comprises a plurality of template entries corresponding to the plurality of predefined terms,
the first prompt further includes an instruction to convert the natural language query into the domain-specific language as expressed in the predefined data structure;
executing, by the conversion language model, the first prompt to output an instance data structure of the predefined data structure, wherein:
the instance data structure stores the natural language query as expressed in a subset of the plurality of predefined terms of the domain-specific language,
executing the first prompt comprises populating the plurality of template entries to generate the instance data structure, and
the instance data structure further stores information from the natural language query as values assigned to the plurality of template entries;
generating a second prompt that instructs the answer generation model to generate a response to the natural language query, wherein the second prompt comprises the instance data structure;
executing, by the answer generation model, the second prompt to generate an answer to the natural language query; and
returning the answer.

2. The method of claim 1, wherein generating the first prompt further comprises:
generating a third prompt that instructs a ranking model to select, from among a plurality of examples, a subset of examples, wherein:
each of the plurality of examples comprises an example natural language query and an example instance data structure of the predefined data structure,
the instance data structure stores the example natural language query as expressed in an example subset of the plurality of predefined terms of the domain-specific language, and
the subset of examples comprises a ranked list of examples that most closely pertain to the natural language query, relative to remaining examples in the plurality of examples;
executing, by the ranking model, the third prompt to generate the subset of examples; and
inserting the subset of examples into the first prompt.

3. The method of claim 2, wherein the ranking model comprises a bidirectional encoder representations from transformers (BERT) language model.

4. The method of claim 1, wherein the instance data structure generated by executing the first prompt includes a dataset name in the domain-specific language and a subset of entity terms defined in the domain-specific language and contained in the natural language query.

5. The method of claim 4, wherein the instance data structure further comprises a subset of terms selected from among a plurality of terms defined in the plurality of predefined terms.

6. The method of claim 4, wherein the dataset name comprises a subset of dataset names selected from among a plurality of dataset names defined in the plurality of predefined terms.

7. The method of claim 1,
wherein the instance data structure defines an entity contained in the natural language query, and
wherein the method further comprises:
disambiguating the entity to generate a revised entity that corresponds to an entry in a database, wherein the entity comprises a first term, and the entry comprises a second term different than the first term; and
revising, prior to executing the second prompt, the instance data structure to generate a revised instance data structure, wherein the second prompt includes the revised entity.

8. The method of claim 1,
wherein the answer is defined as a second instance of the domain-specific language,
wherein the method further comprises generating a third prompt that instructs a reporting model to convert the second instance of the domain-specific language into a natural language answer, and
wherein returning the answer comprises returning the natural language answer.

9. The method of claim 8, wherein the natural language answer comprises a summary of the second instance of the domain-specific language.

10. The method of claim 1,
wherein the instance data structure comprises a first command to an application-specific program,
wherein the method further comprises:
calling, prior to executing the second prompt, an application programming interface (API) of the application-specific program and requesting the application-specific program to execute the command;
receiving, via the API, an output of the application-specific program; and
revising the instance data structure by inserting the output into the instance data structure to generate a revised instance data structure, and
wherein the second prompt includes the revised instance data structure.

11. The method of claim 1,
wherein the instance data structure comprises a first command to an application-specific program and a second command to a domain-specific program,
wherein the method further comprises:
calling, prior to executing the second prompt, a first application programming interface (API) of the application-specific program and requesting the application-specific program to execute the first command;
receiving, via the first API, a first output of the application-specific program;
calling, prior to executing the second prompt, a second API of the domain-specific program related to the domain and requesting the domain-specific program to execute the second command using the first output;
receiving, via the second API, a second output of the domain-specific program; and
revising the instance data structure by inserting the second output into the instance data structure to generate a revised instance data structure, and
wherein the second prompt includes the revised instance data structure.

12. A system comprising:
a computer processor;
an answer generation model in communication with the computer processor;
a conversion language model in communication with the computer processor;
a data repository in communication with the computer processor and storing:
a natural language query to the answer generation model and comprising a domain, wherein the domain comprises a subject of the natural language query or an area of knowledge,
a first prompt that instructs the conversion language model to convert the natural language query into a domain-specific language corresponding to the domain of the natural language query, wherein:
the domain is associated with a command or structure expressed in the domain-specific language and the domain-specific language is specific to the domain,
the domain-specific language comprises a plurality of predefined terms, as used in the subject of the query or the area of knowledge of the domain, representable in a predefined data structure,
the plurality of predefined terms include the command or structure of the domain,
the first prompt includes a predefined data structure template that includes the command or structure,
the predefined data structure template comprises a plurality of template entries corresponding to the plurality of predefined terms, and
the first prompt further includes an instruction to convert the natural language query into the domain-specific language as expressed in the predefined data structure,
an instance data structure of the predefined data structure, wherein the instance data structure stores the natural language query as expressed in a subset of the plurality of predefined terms of the domain-specific language, and wherein the instance data structure further stores information from the natural language query as values assigned to the plurality of template entries,
a second prompt that instructs the answer generation model to generate a response to the natural language query, wherein the second prompt comprises the instance data structure, and
an answer to the natural language query; and
a server controller executable by the computer processor to:
receive the natural language query,
generate the first prompt,
execute the conversion language model on the first prompt to output the instance data structure, wherein executing the conversion language model on the first prompt comprises populating the plurality of template entries to generate the instance data structure,
generate the second prompt,
execute the answer generation model on the second prompt to generate the answer, and
return the answer.

13. The system of claim 12, wherein generating the first prompt further comprises:
generating a third prompt that instructs a ranking model to select, from among a plurality of examples, a subset of examples, wherein:
each of the plurality of examples comprises an example natural language query and an example instance data structure of the predefined data structure,
the instance data structure stores the example natural language query as expressed in an example subset of the plurality of predefined terms of the domain-specific language, and
the subset of examples comprises a ranked list of examples that most closely pertain to the natural language query, relative to remaining examples in the plurality of examples;
executing, by the ranking model, the third prompt to generate the subset of examples; and
inserting the subset of examples into the first prompt.

14. The system of claim 13, wherein the ranking model comprises a bidirectional encoder representations from transformers (BERT) language model.

15. The system of claim 12, wherein the instance data structure generated by executing the first prompt includes a dataset name in the domain-specific language and a subset of entity terms defined in the domain-specific language and contained in the natural language query.

16. The system of claim 15, wherein:
the instance data structure further comprises a subset of terms selected from among a plurality of terms defined in the plurality of predefined terms, and
the dataset name comprises a subset of dataset names selected from among a plurality of dataset names defined in the plurality of predefined terms.

17. The system of claim 12, wherein the system further comprises:
an application-specific program in communication with the computer processor and comprising an application programming interface (API),
wherein the instance data structure comprises a first command to the application-specific program,
wherein the server controller is further executable to:
call, prior to executing the second prompt, the API and request the application-specific program to execute the command;
receive, via the API, an output of the application-specific program; and
revise the instance data structure by inserting the output into the instance data structure to generate a revised instance data structure, and
wherein the second prompt includes the revised instance data structure.

18. The system of claim 12,
wherein the system further comprises:
an application-specific program in communication with the computer processor and comprising a first application programming interface (API); and
a domain-specific program, related to the domain, in communication with the computer processor and comprising a second API,
wherein the instance data structure comprises a first command to the application-specific program and a second command to the domain-specific program,
wherein the server controller is further configured to:
call, prior to executing the second prompt, the first API of the application-specific program and request the application-specific program to execute the first command;
receive, via the first API, a first output of the application-specific program;
call, prior to executing the second prompt, the second API and request the domain-specific program to execute the second command using the first output;
receive, via the second API, a second output of the domain-specific program; and
revise the instance data structure by inserting the second output into the instance data structure to generate a revised instance data structure, and
wherein the second prompt includes the revised instance data structure.

19. A method comprising:
receiving a natural language query to an answer generation model, wherein the natural language query comprises a domain, and wherein the domain comprises a subject of the natural language query or an area of knowledge;
generating a first prompt that instructs a conversion language model to convert the natural language query into a domain-specific language corresponding to the domain of the natural language query, wherein:
the domain is associated with a command or structure expressed in the domain-specific language and the domain-specific language is specific to the domain,
the domain-specific language comprises a plurality of predefined terms, as used in the subject of the query or the area of knowledge of the domain, representable in a predefined data structure,
the plurality of predefined terms include the command or structure of the domain,
the first prompt includes a predefined data structure template that includes the command or structure,
the first prompt further includes an instruction to convert the natural language query into the domain-specific language as expressed in the predefined data structure,
the predefined data structure template comprises a plurality of template entries corresponding to the plurality of predefined terms,
and wherein generating the first prompt further comprises generating a third prompt that instructs a ranking model to select, from among a plurality of examples, a subset of examples, wherein:
each of the plurality of examples comprises an example natural language query and an example instance data structure of the predefined data structure,
the example instance data structure stores the example natural language query as expressed in an example subset of the plurality of predefined terms of the domain-specific language, and
the subset of examples comprises a ranked list of examples that most closely pertain to the natural language query, relative to remaining examples in the plurality of examples, and
the ranking model comprises a bidirectional encoder representations from transformers (BERT) language model;
executing, by the ranking model, the third prompt to generate the subset of examples; and
inserting the subset of examples into the first prompt;
executing, by the conversion language model, the first prompt to output an instance data structure of the predefined data structure, wherein:
the instance data structure stores the natural language query as expressed in a subset of the plurality of predefined terms of the domain-specific language,
the instance data structure defines an entity contained in the natural language query,
executing the first prompt comprises populating the plurality of template entries to generate the instance data structure, and
the instance data structure further stores information from the natural language query as values assigned to the plurality of template entries;
disambiguating the entity to generate a revised entity that corresponds to an entry in a database, wherein the entity comprises a first term, and the entry comprises a second term different than the first term;
revising the instance data structure to generate a revised instance data structure;
generating a second prompt that instructs the answer generation model to generate a response to the natural language query, wherein the second prompt comprises the revised instance data structure;
executing, by the answer generation model, the second prompt to generate an answer to the natural language query; and
returning the answer.

20. The method of claim 19,
wherein the revised instance data structure comprises a first command to an application-specific program and a second command to a domain-specific program, and
wherein the method further comprises:
calling, prior to executing the second prompt, a first application programming interface (API) of the application-specific program and requesting the application-specific program to execute the first command;
receiving, via the first API, a first output of the application-specific program;
calling, prior to executing the second prompt, a second API of the domain-specific program related to the domain and requesting the domain-specific program to execute the second command using the first output;
receiving, via the second API, a second output of the domain-specific program; and
revising the revised instance data structure by inserting the second output into the instance data structure to generate a second revised instance data structure,
wherein the second prompt includes the second revised instance data structure in place of the revised instance data structure.
